(19) United States
(12) Patent Application Publication
(10) Pub. No.: US 2003/0169525 A1
(43) Pub. Date: Sep. 11, 2003

(54) Information storage medium, information recording apparatus, and information playback apparatus

(76) Inventors: Akihito Ogawa, Yokohama-shi (JP); Hideo Ando, Hino-shi (JP); Kazuo Watabe, Yokohama-shi (JP); Shintaro Takehara, Yokohama-shi (JP); Kazuto Kuroda, Kawasaki-shi (JP); You Yoshioka, Yokohama-shi (JP)

Correspondence Address: PILLSBURY WINTHROP, LLP, P.O. BOX 10500, MCLEAN, VA, 22102, US

(21) Appl. No.: 10/330,012

(22) Filed: Dec. 27, 2002

(30) Foreign Application Priority Data
Dec. 28, 2001 (JP) 2001-401104

(51) Int. Cl. G11B 5/02

(52) U.S. Cl. 360/29

(57) ABSTRACT

An information storage medium includes a wobbled track containing a wobble modulated in correspondence with playback control information. The playback control information contains address data. Part of the address data contains at least one item of sync information. The frequency of the wobble changes at the boundary of the sync information.

### CROSS-REFERENCE TO RELATED APPLICATIONS

This application is based upon and claims the benefit of priority from the prior Japanese Patent Application No. 2001-401104, filed Dec. 28, 2001, the entire contents of which are incorporated herein by reference.

### BACKGROUND OF THE INVENTION

1. Field of the Invention

The present invention relates to an information storage medium having grooves that are concentrically or spirally formed. The present invention also relates to an information recording apparatus for recording information on said information storage medium. The present invention also relates to an information playback apparatus for playing back information from said information storage medium.

2. Description of the Related Art

To record information at an arbitrary position in the information recording area of an information storage medium or play back information recorded on the information storage medium, a physical absolute address on the information storage medium is necessary. In a CD-R or CD-RW, a track called a groove on the information storage medium wobbles to record address information by FM modulation as physical absolute addresses. Symbols of FM modulation are 22.05 kHz+1 kHz and 22.05 kHz−1 kHz. User information is recorded for each error correction block on the basis of the address information. Since the address information is recorded by wobble modulation of grooves, the grooves have no discontinuity. User information can be continuously recorded on the grooves. This is advantageous in recording continuous information. Since no unwanted information such as control information is inserted, the format is efficient. Jpn. Pat. Appln. KOKAI Publication No. 9-27127 discloses a technique for recording address information by wobble modulation, like a CD-R or CD-RW.

In a DVD-RAM, address information called CAPA is recorded for each physical sector using a pre-pit as a physical absolute address. Grooves end at portions where pre-pits are formed. Since address information is recorded not as a wobbled groove but as a pre-pit, recorded user information and physical address information can easily be separated. In addition, since the accuracy of the address information played back is high, and the boundary between a pre-pit and a groove can easily be detected, the detection accuracy of the recording start position becomes high. Furthermore, since an address is recorded for each physical sector, a desired physical sector can quickly be randomly accessed in recording/playing back user information.

As described above, in the CD-R or CD-RW, address information is recorded by FM modulation by wobbling a track called a groove on the information storage medium. However, the address information is detected only for each error correction block. In addition, the change in frequency between symbols of FM modulation is small, and the read accuracy is low. For these reasons, it is difficult to quickly and accurately access a desired address using only a wobbled signal in recording or playing back user information. Additionally, since information rewrite can also be done only for each error correction block, it is impossible to manage defects for a unit smaller than the error correction block. Furthermore, control information for address information detection, e.g., an area used to obtain an address information read frequency or identification information used to identify the area, and information indicating an address start position are not completely present, or a method of easily detecting these pieces of information does not exist. For this reason, the address information cannot quickly and accurately be read. Also, since there is no highly accurate information indicating a recording start position, the recording start position positioning accuracy is low. To add or rewrite user information, a buffer area for linkage is necessary for protecting already recorded information. This leads to a decrease in recording capacity and redundant recording time. Jpn. Pat. Appln. KOKAI Publication No. 9-27127 has the same problems as described above.

As described above, in the DVD-RAM, address information, i.e., CAPA is recorded for each physical sector as a physical absolute address using a pre-pit. Since the groove ends at a portion having a pre-pit, user information cannot be continuously recorded. Hence, it is disadvantageous in recording seamless information such as video information. In addition, even in playing back recorded information, user information is interrupted by pre-pit information. For this reason, the DVD-RAM format is not compatible with a DVD-ROM, i.e., a read-only disk. It is a technical problem in playing back a DVD-RAM by a read-only drive. Furthermore, the DVD-RAM that uses a phase change medium for recording/playing back user information has a VFO area, guard area, buffer area, and the like in addition to address information at a pre-pit portion. No user information can be recorded at this portion. For this reason, the recording capacity substantially greatly decreases, resulting in a problem.

The present invention has been made to solve the above problems, and has as its object to provide an information recording medium more suitable for recording/playback of user information.

### BRIEF SUMMARY OF THE INVENTION

In order to solve the above problems and achieve the object, an information storage medium of the present invention has the following arrangement.

According to the present invention, there is provided an information storage medium comprising a wobbled track containing a wobble modulated in correspondence with playback control information, wherein the playback control information contains header data, part of the header data contains at least one item of sync information, and the frequency of the wobble changes at a boundary of the sync information.

Additional objects and advantages of the present invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention and, together with the general description given above and the detailed description of the preferred embodiments given below, serve to explain the principles of the invention.

FIG. 1 is a view showing the structure of an information storage medium of the present invention;

FIG. 2 is a view showing layout relationship 1 between wobbled data contents and user data;

FIG. 3 is a view showing layout relationship 2 between wobbled data contents and user data;

FIG. 4 is a view showing four orthogonal frequencies and wobble clock;

FIG. 5 is a view showing layout relationship 3 between wobbled data contents and user data;

FIG. 6 is a view showing the schematic arrangement of an information recording/playback apparatus according to an embodiment of the present invention;

FIG. 7 is a block diagram showing the schematic arrangement of a wobbled signal demodulation circuit;

FIG. 8 is a view showing relationship 1 between the wobbled data and the delay detection circuit output signal;

FIG. 9 is a flowchart for explaining initial operation for playing back information from the information storage medium;

FIG. 10 is a flowchart showing an access/playback control method;

FIG. 11 is a flowchart showing a recording control method;

FIG. 12 is a view showing relationship 2 between the wobbled data and the delay detection circuit output signal;

FIG. 13 is a view showing wobble pattern 1 in each area; and

FIG. 14 is a view showing wobble pattern 2 in each area.

### DETAILED DESCRIPTION OF THE INVENTION

An embodiment of the present invention will be described below with reference to the accompanying drawing.

The point of the present invention will be described first.

An information storage medium according to an embodiment of the present invention has a wobbled track including a wobble modulated in correspondence with playback control information. The playback control information contains header data and address data following the header data. At least a piece of sync information is assigned to part of the header data and address data. The frequency of wobble changes at the boundary of sync information. The sync information is recorded at a predetermined frequency or in a special pattern. The modulation scheme of the wobble that records sync information is multi-frequency shift keying. The frequencies of symbols contained in multi-frequency shift keying have an orthogonal relationship.

Pieces of sync information are arranged at the start position of address data and at the start and end positions of header data and used to discriminate the start of address data and the start and end of header data.

Sync information is formed for each word. In specific sync information, at least one of a plurality of time slots of one word has a frequency different from that of the remaining time slots contained in the same sync information. These frequencies have an orthogonal relationship.

The wobbled track has a plurality of segment areas. Header data and address data are arranged in one segment area. A plurality of sector data are recorded in one segment in synchronism with sync information contained in the header data and address data.

Playback control information is reflected in the wobble period of the wobbled track. In other words, the playback control information is recorded as a wobble of the track. When the playback control information is reflected in the wobble period of the wobbled track, the track need not be interrupted. As a result, user information can be seamlessly recorded. The header data and address data contained in the playback control information contain sync information. Each sync information has a specific pattern, or the frequency switches at the boundary between sync information. Various kinds of information contained in the playback control information can be accurately played back and discriminated on the basis of the difference between patterns or a change in frequency.

Multi-frequency shift keying is used as the modulation scheme of the wobble for recording at least sync information. The frequencies of symbols used for multi-frequency shift keying have an orthogonal relationship. Since the symbols have an orthogonal relationship, each symbol can easily be detected. For example, when a delay detection method using the orthogonal relationship is used, sync information can be accurately read, and playback control information can be reliably played back. More specifically, when pieces of information indicating the recording start position of user recording information, the address start position of a segment, the start and end positions of header data, and the recording start position of user information are arranged as sync information, these pieces of information can be accurately detected. As a result, the positioning accuracy of the recording/playback start position of user information increases. In addition, the information discrimination accuracy increases and the discrimination method can be simplified.

The playback control information is formed for each word. Normally, the modulation symbol does not change in one word. For specific sync information, some of a plurality of time slots of one word are switched. Consequently, since the delay detection output changes in one word of this specific sync information, this information can easily and accurately be identified from the remaining playback control information.

The wobbled track is divided into a plurality of segment areas each of which contains header data and address data. User data is recorded as a plurality of sector data on the basis of the sync information of each segment. Pieces of information representing the address data start position and user information recording start position are recorded as sync signals descried above. Accordingly, when the characteristic sync signal is detected, the header data start position or user recording information recording start position of the segment can be accurately specified or discriminated. In addition, user information can easily be recorded using the address of a segment.

An information storage medium such as a CD-R or CD-RW and the information storage medium of the present invention are different in four points. As the first point, as signals recorded by wobbling a groove, not only address information but also various kinds of sync signals are recorded by signals of predetermined frequencies. The sync signals include, e.g., a wobbled address mark indicating the start of address data, a wobbled VFO for PLL pull-in, a wobbled pre-synchronous code, and a wobbled postamble. As the second point, the sync information is switched at the boundary or recorded using a pattern different from those in the remaining areas. As the third point, frequencies having an orthogonal relationship are used as symbols of FM modulation, and the wobbled information is played back using the orthogonal relationship. As the fourth point, information is recorded for each segment different from an error correction block.

In the information storage medium of the present invention, address information is recorded by wobbling a track called a groove by multi-frequency shift keying, and no pre-pit is inserted by interrupting the groove, unlike the conventional DVD-RAM. Hence, the information storage medium of the present invention is suitable for seamless recording. In addition, it has a high user information storage efficiency.

This embodiment will be described below with reference to the accompanying drawing.

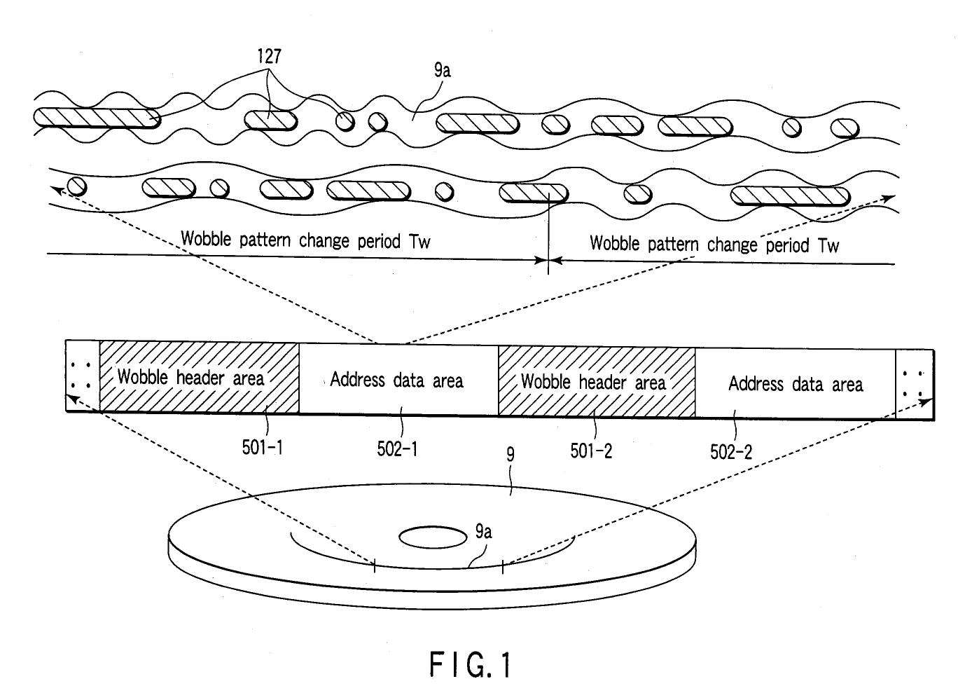

FIG. 1 is a view showing the structure of the information storage medium according to the embodiment of the present invention.

As shown in FIG. 1, a groove 9a is concentrically or spirally formed in an information storage medium 9. The groove 9a is called a track. A projecting portion is called a groove and a recessed portion is called a land. Information is recorded as a recording mark 127 along the track. The track wobbles, as shown in the first column of FIG. 1. When the frequency of the wobble is changed, i.e., frequency modulation (FM) is performed, information can be recorded on the track. In this information storage medium 9, control information such as address data indicating a physical position on the disk is formed at the time of manufacturing the disk. Hence, when a user should use the information storage medium 9, and he/she has recorded no information yet, physical addresses on the upper surface of the disk have already been determined.

Information recording/playback is done by irradiating the disk with a light beam for playback along the track. For example, in the information storage medium 9 using a phase change medium, a signal can be played back in accordance with the reflectance difference between an amorphous state and a crystalline state. When the recording mark 127 is recorded as an amorphous portion, the reflectance of this portion is different from that of the remaining crystal portion. When reflected light from the track is detected, the change in reflectance of the track, which is reflected on the reflected light, is played back as information. The reflected light also contains a wobbled component. When the wobbled component contained in the reflected light is detected and extracted as a wobbled signal, a spindle motor rotation control signal or address information indicating a physical position on the disk can be played back. In addition, the wobbled signal clearly appears as a signal called a difference signal, while the information of the recording mark 127 clearly appears as a signal called a sum signal. When the difference signal and sum signal are separately detected, the wobbled signal and the signal by the recording mark 127 can be separated. Hence, the wobbled signal is not obstructive in playing back user information recorded by the recording mark 127. Information is recorded by modulating the light intensity. For example, when a phase change medium is used as a recording medium, the phase change medium is irradiated with strong light. When the medium is melted and rapidly cooled, the recording mark 127 in the amorphous state is formed. Even when a dye film is used for the recording medium, strong light irradiation on the film induces chemical and physical changes in the dye film, so the recording mark 127 can be formed.

As shown in the second column of FIG. 1, the track is divided into a plurality of areas. The areas include two areas, i.e., an address data area 502 in which address information indicating a physical position on the disk by the above-described wobbled signal is arranged, and a wobbled header area 501 in which control information such as sync information used to play back the signal recorded in the address data area 502 is recorded. In this embodiment, a set of the wobbled header area 501 and address data area 502 is defined as one segment. The track is divided into a plurality of segments. The address of each segment can be known by playing back address information recorded by a wobbled signal.

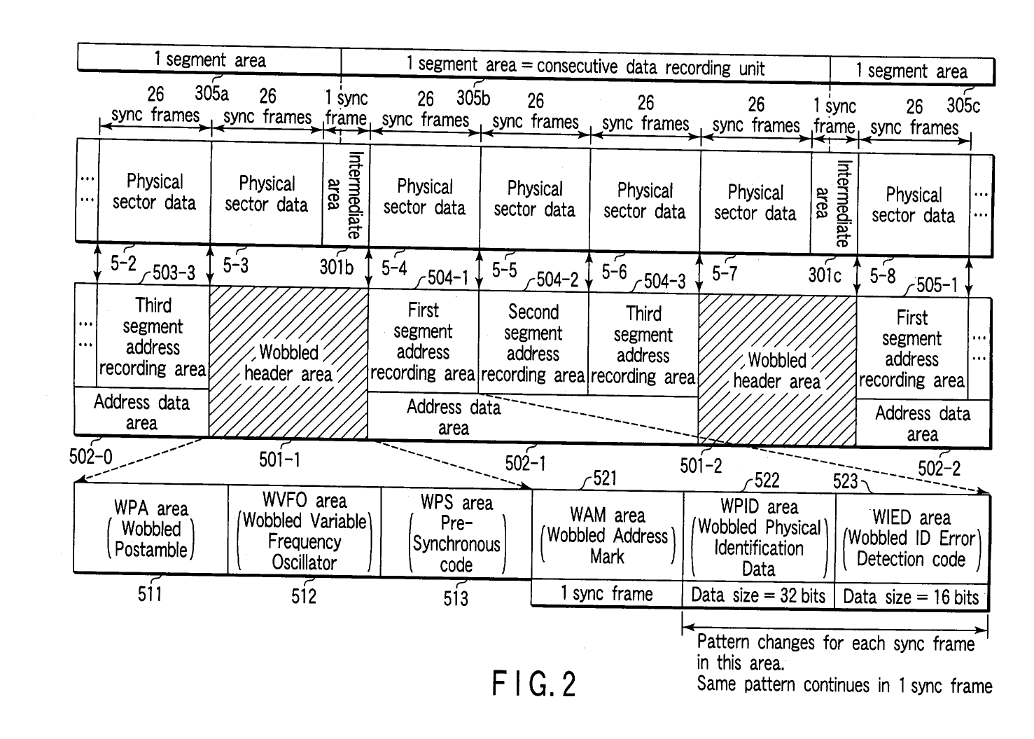

The structure of a segment and the layout of user information will be described next. FIG. 2 shows the layout relationship between the segment structure and user data.

As shown in the second column of FIG. 1, one segment ranges from the start of a wobbled header area 501-1 to the end of an address data area 502-2. As shown in the third column of FIG. 2, the address information of the segment is recorded three times in one address data area 502 (502-0, 502-1, and 502-2) by wobble modulation. These segment addresses in one address data area 502 are identical. That is, the address information is written three times. In playing back address information, pieces of playback information of these three addresses are decided by majority to increase the address read accuracy. As a consequence, a segment address read error hardly occurs. The playback information can be said to be accurate address information.

The structure of a segment address is shown in the fourth column of FIG. 2. The segment address is formed from a WAM area 521, WPID area 522, and WIED area 523. A wobbled address mark indicating the start of address information is recorded in the WAM area 521. Wobbled physical identification data as address information is recorded in the WPID area 522. A wobbled ID error detection code as error correction information of the address information is recorded in the WIED area 523.

In addition to the above-described address information, a plurality of pieces of control information are laid out even in the wobbled header area 501 (501-1 and 501-2). The fourth column of FIG. 2 shows control information laid out in the wobbled header area 501.

A wobbled postamble indicating the start of the segment, i.e., the end of the immediately preceding segment is recorded in a WPA area 511. A wobble having a predetermined frequency is recorded in a WVFO area 512, which is used to, e.g., pull in a PLL clock in recording/playing back information. A wobbled pre-synchronous code representing the end of the WVFO area 512 and used for synchronization with the start of recording is recorded in a WPS area 513.

The layout relationship between wobbled data and user data in this embodiment will be described next. The second and third columns of FIG. 2 show the layout relationship between wobbled data and user data. Four physical sector data 5 and one intermediate area 301 are laid out in one segment formed from the wobbled header area 501-1 and address data area 502-1. The four physical sector data 5 and intermediate area 301 from an intermediate area 301b to an intermediate area 301c form one segment in recording user information. The user data is recorded or rewritten using one segment as a minimum unit. The length of each segment address 504 in the address data area 502 equals that of the physical sector data 5. The segment data and physical sector data have almost the same start position. The start position of the wobbled header area 501 is also almost the same as that of the physical sector data 5. When, e.g., a phase change medium is used as the recording medium, the recording start position is shifted by several bytes in some cases to reduce degradation due to overwrite of recording information. For this reason, the start position of the segment address 504 or wobbled header area 501 and that of the physical sector 5 are shifted within that range.

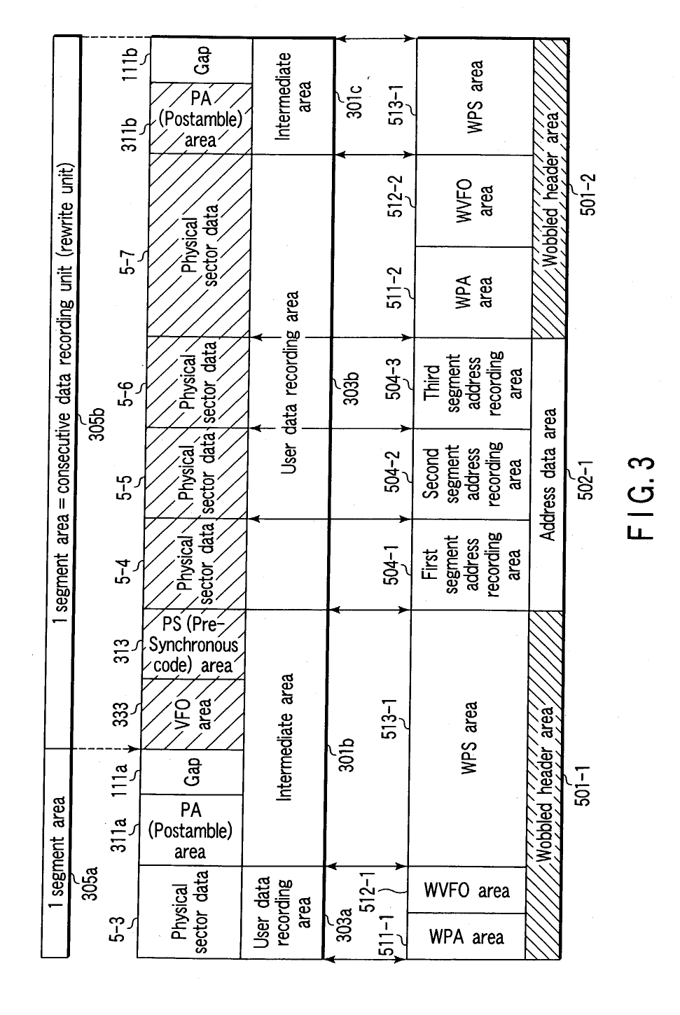

The structure of user data will be described next. FIG. 3 shows the structure of user data. FIG. 3 mainly shows the structure of one segment of user data. One segment of user data is formed from a VFO area 333, PS area 313, four physical sector data 5, and PA area 311. A VFO area 111a is provided to maintain synchronization between one segment of a wobbled signal and one segment of user data. The physical sector data 5 starts simultaneously with the end of the wobbled header area. A predetermined frequency signal is recorded in the VFO area 333 and used to, e.g., pull in the PLL clock in the playback mode. A pre-synchronous code indicating the start of physical sector data is recorded in the PS area 313. A postamble indicating the end of physical sector data is recorded in the PA area 311. The data recorded in the VFO area 333, PS area 313, and PA area 311 are management/control information. Actual user data is recorded in each physical sector as the physical sector data 5. An area where management/control information is recorded is defined as the intermediate area 301. An area where user information is recorded is defined as a user data recording area 303.

In this embodiment, the minimum unit of recording or rewrite of user data is one segment. Recording or rewrite is consecutively executed through one segment. That is, recording of user data or rewrite of data including the four consecutive physical sectors 5 is done simultaneously from the VFO area 333 to the VFO area 111a.

The frequency modulation scheme as the wobbled signal modulation method of this embodiment will be described next. A wobble pattern is generated by executing binary or orthogonal multi-frequency shift keying for playback control information. Four-frequency shift keying will be described here. In 4-frequency shift keying, four waves having different frequencies are used as symbols F1, F2, F3, and F4. Orthogonal multi-frequency shift keying will be described below.

Modulation index m between adjacent frequencies Time slot interval Ts (time necessary for sending one symbol)

1≦i≦4 (i is an integer) (0)

(Fᵢ₊₁−Fᵢ)Tₛ=m (1)

$$\begin{matrix}{F}_{C} ≡ \frac{{F}_{2} + {F}_{3}}{2} & ( 2 ) \\ Δ F ≡ \frac{{F}_{i + 1} - {F}_{i}}{2} = \frac{m}{2 {T}_{S}} & ( 3 ) \\ {F}_{i} = {F}_{C} + ( 2 i - 5 ) Δ F = {F}_{C} + \frac{( 2 i - 5 ) m}{2 {T}_{S}} & ( 4 )\end{matrix}$$

When the minimum frequency F₁ is arranged at period N/2 (N is an integer) within the time slot interval Ts, the following relationship holds:

$${F}_{1} = \frac{N}{2 {T}_{S}} \qquad ( 5 )$$

Equations (4) and (5) can be rewritten to

$$\begin{matrix}{F}_{C} = \frac{N + 3 m}{2 {T}_{s}} & ( 6 ) \\ {F}_{i} = \frac{N + ( 2 i - 2 ) m}{2 {T}_{S}} & ( 7 )\end{matrix}$$

A period nᵢ in which each Fᵢ present within the time slot interval Ts is given by

$${n}_{i} = \frac{{F}_{C}}{1 + {T}_{S}} = \frac{N}{2} + ( i - 1 ) m \qquad ( 8 )$$

where Fᵢ is the frequency corresponding to each symbol, F_{c} is the center frequency, and ΔF is the frequency shift

In addition, orthogonal frequency modulation that satisfies the above frequency relationship occurs under a condition given by

$$Δ F \cdot {T}_{S} = m = \frac{N}{2} ( N is an integer ) \qquad ( 9 )$$

In this embodiment, orthogonal 4-frequency shift keying having the frequency relationship shown above is used. In this embodiment, one time slot interval Tₛ is assigned to the length of one period of F1, so m=0.5 and N=2.

When m=0.5 and N=2, and binary modulation is executed using only i=1 and i=2, so-called MSK (Minimum Shift Keying) is executed.

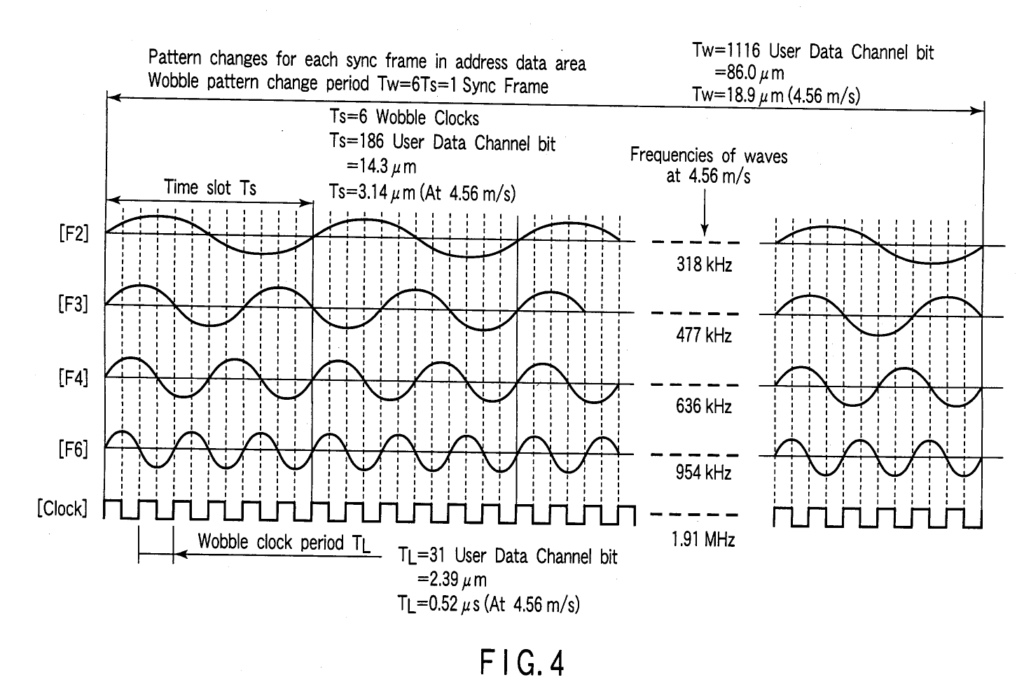

FIG. 4 is an explanatory view of wobble pattern contents in the embodiment of the present invention when the read from the information storage medium 9 is executed at CLV (Constant Linear Velocity), and orthogonal 4-frequency shift keying is used. For example, assume that F1 is set at 318 kHz when the linear velocity is 4.56 m/s. Then, the frequencies representing symbols are 318 kHz (F2), 477 kHz (F3), 636 kHz (F4), and 954 kHz (F6) on the basis of the above-described relationship.

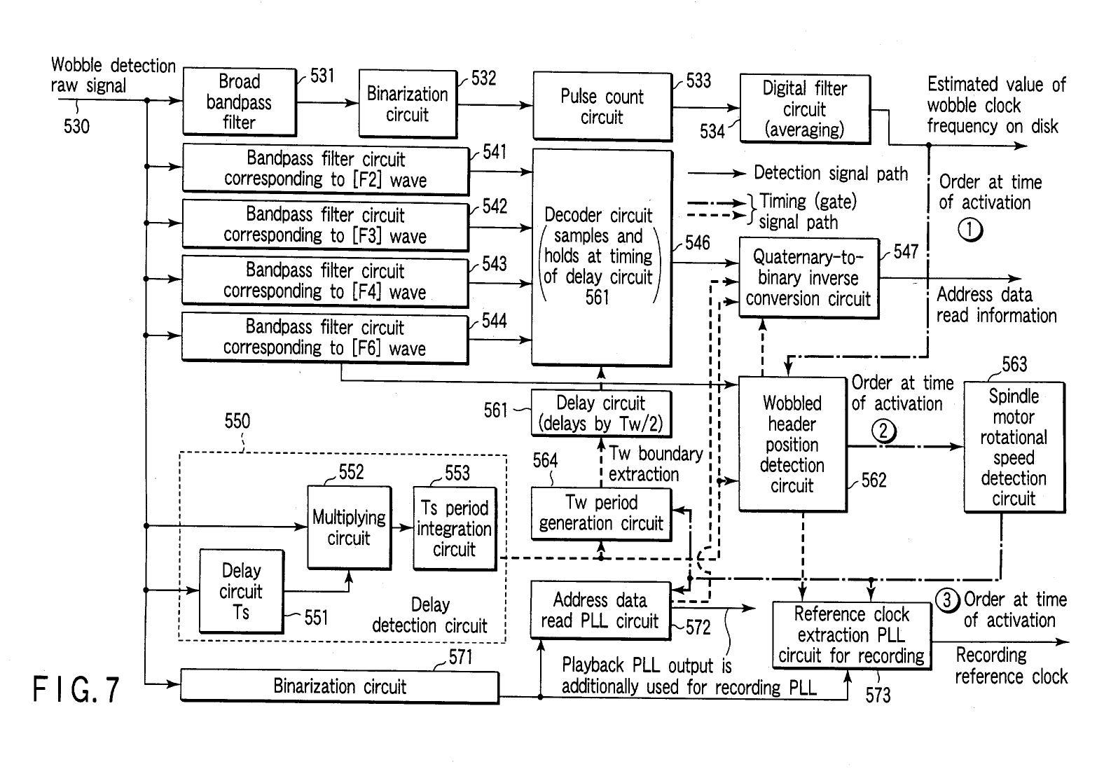

As the most characteristic point of the present invention, [F2]:[F3]=2:3, and [F2]:[F4] or [F3]:[F6]=1:2. This makes the length of a time slot Ts common to the four waves in FIG. 4 relatively small and also the relative length of a wobble clock period TL common to the four waves large. As a result, the structure of the demodulation circuit shown in FIG. 7 can be simplified, and the demodulation reliability increases. In the relationship between the frequency and the linear velocity exemplified in FIG. 4, the time slot interval Ts is 3.14 μs, and its length on the disk is 14.3 μm. In addition, one symbol is changed for every 6 Ts, and its length is made match one sync frame length Tw in the DVD format. One symbol or one wobbled word corresponds to the wobble pattern change period Tw. As shown in FIG. 4, in the present invention, since a wobble having four frequencies corresponds to that period, two bits (two wobble bits) correspond to the period by binary expression for one symbol (one wobbled word). When one symbol (one wobbled word) is assigned to each time slot Ts, the recording efficiently is highest. However, problems (1) to (3) are posed.

(1) If even a small physical defect is present in a wobble pattern, a detection error or data shift readily occurs.

(2) The delimiter of each symbol (one wobbled word) Tw is difficult to detect.

(3) The reliability of data detection for each symbol (one wobbled word) Tw is low.

To solve these problems, a plurality of time slots are assigned to one symbol (one wobbled word) to set Tw=LTs (L is an integer). The frequency is constant through a symbol (one wobbled word). Accordingly, since the number of wobbles contained in one symbol (one wobbled word) Tw increases, effects (1) to (3) below are obtained.

(1) A detection error rarely occurs even depending on the physical result in the wobble pattern, and the data detection reliability increases.

(2) When a delay detection circuit 550 is used, the end of each symbol (one wobbled word) can easily be detected.

(3) Accurate detection can be executed using bandpass filter circuits 541 to 544 having a very simple structure.

FIG. 4 shows an example of 4-MSK using four different frequencies. However, the characteristic feature of the present invention can also be applied to a method using two wavelengths. For example, even in a method (binary MSK) using [F2] and [F3] in FIG. 4, when Tw=LTs, the same effects as described above can be obtained.

As described above, the four frequency patterns of F2 to F6 have an orthogonal relationship. For this reason, the end of data for each sync frame can easily be detected using delay detection. Letting s(t) be the input, the delay detection output is given by

$${\int }_{0}^{t} s ( t ) \cdot s ( t - {T}_{S} ) \qquad ( 10 )$$

The delay detection output is normalized. The symbols in this embodiment have an orthogonal relationship. Hence, while one symbol continues, the delay detection output is 1. When the symbol switches, the output changes to 0. Hence, when information is to be recorded on the track by wobble modulation, encoding is performed such that the wobble pattern always changes for each sync frame in an area except an area where special control information is recorded, e.g., in the address data area 502. Then, since the end of one sync frame (i.e., the end for each symbol interval Tw) is detected from the delay detection output, timing generation at the time of modulation becomes easy. In an area such as the wobbled header area where special control information is recorded, i.e., in the area where sync information is recorded, the wobble pattern is not switched for each sync frame. The wobble pattern is continuously recorded in a length that is not present in the modulation rule used for modulation of normal address information. Alternatively, the wobble pattern is switched for each time slot in one wobbled word Tw. Then, the control information can be extracted from the delay detection output.

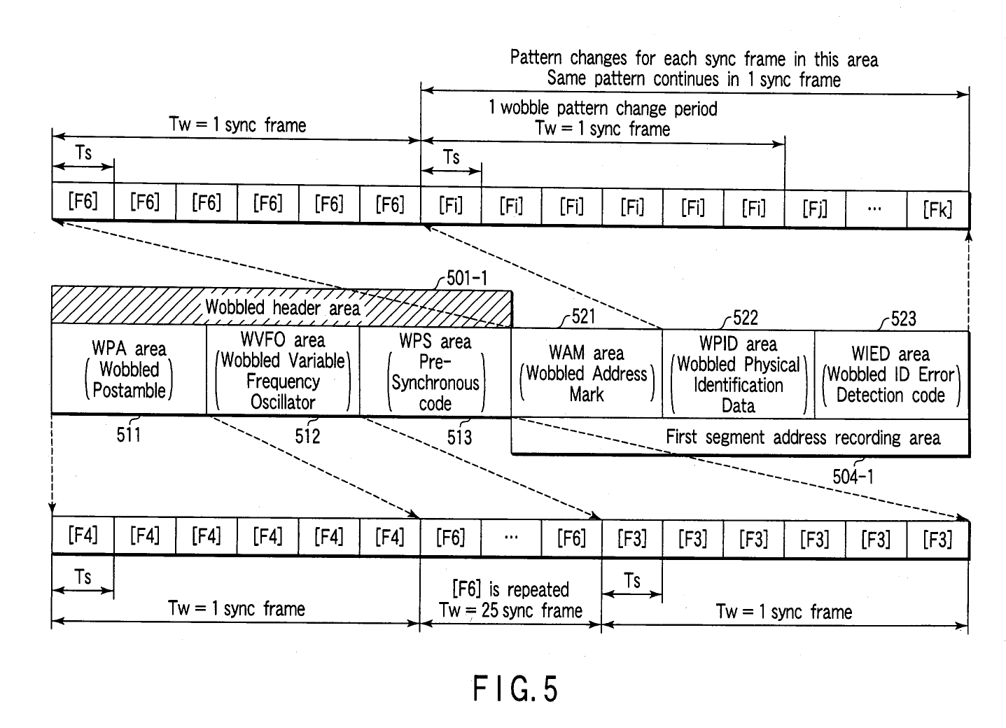

Detailed contents of a wobbled signal recorded in each area will be described next. FIG. 5 is a view showing an example of wobbled signals according to the first embodiment of the present invention. More specifically, FIG. 5 shows wobbled signals recorded in the wobbled header area 501-1 and a first segment address recording area 504-1. Signals identical to that in the first segment address recording area 504-1 are recorded in a second segment address recording area 504-2 and third segment address recording area 504-3. F4 is repeatedly recorded in the WPA area 511 as a postamble. F6 is repeatedly recorded in the WVFO area 512 as wobbled VFO. F3 is repeatedly recorded in the WPS area 513 as a wobbled pre-synchronous code. F6 is repeatedly recorded in the WAM area 521 again as a wobbled address mark. A value obtained by modulating the address information of the segment is recorded in the WPID area 522 by switching the symbol for each sync frame. A value obtained by modulating the error correction information of the address information of the segment is recorded in the WIED area 523 by switching the symbol for each sync frame. The length of consecutive F6 in the WVFO area 512 is much larger than the run-length limit maximum length of the modulation rule used in the WPID area 522 and WIED area 523. For this reason, if the continuous period of F6 is checked, and it is larger than the run-length limit maximum length, it can easily be determined that the area is the WVFO area 512 in the wobbled header area 501. Recording F4 in the WPA area 511 is determined in advance. The rough timing at which the WVFO area 512 starts is detected from rotation of the disk or the generation period of each area. When F4 that has appeared is detected at that timing, the accurate start position of the WVFO area 512, i.e., the accurate position of the wobbled header area 501 can be discriminated. Similarly, the frequency of the symbol in the WPS area 513 or WAM area 521 is also determined in advance, and the symbol is switched in each area. For this reason, each area can be accurately discriminated using the same detection scheme as described above.

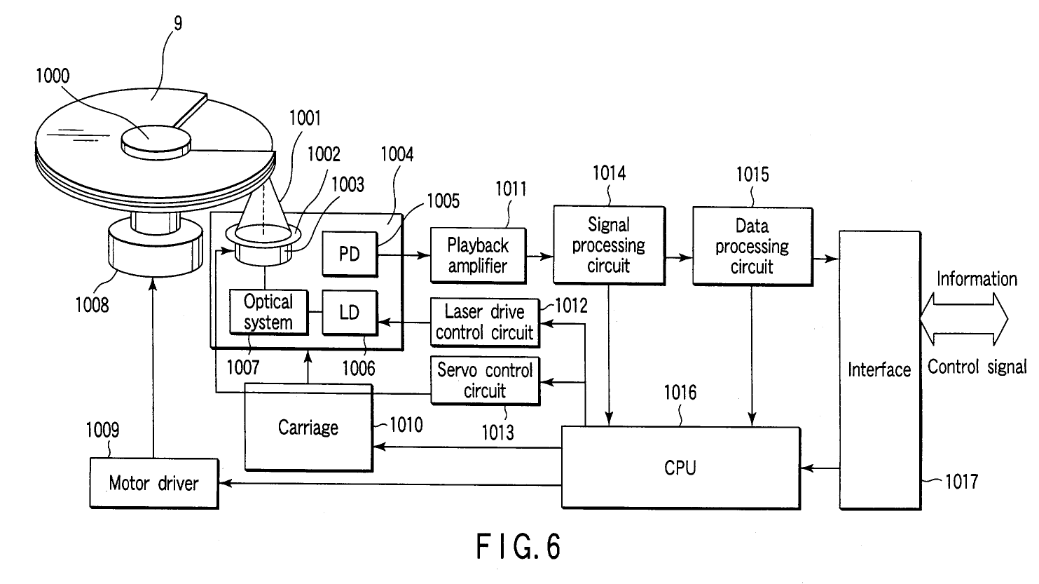

An information recording/playback apparatus for recording/playing back information on/from the information storage medium 9 will be described next. FIG. 6 shows the information recording/playback apparatus of this embodiment. The recording/playback operation by the information recording/playback apparatus is controlled by a CPU 1016. The information storage medium 9 of this embodiment is attached to a spindle motor 1008 by a damper 1000. The spindle motor 1008 is driven by a motor driver 1009. An optical head 1004 opposes the rotating information storage medium 9. Information is recorded on or played back from the information storage medium 9 by a light beam 1001 emitted from the optical head 1004.

The optical head 1004 has an objective lens 1002, a lens actuator 1003 which moves the objective lens 1002 in the focus direction and radial direction of the disk, an optical system 1007 for recording/playback, a violet semiconductor laser LD 1006, a division photodetector PD 1005 for detecting a playback signal from reflected light from the information storage medium 9, and the like. The lens actuator 1003 moves the objective lens 1002 in the focus direction and in the radial direction of the disk on the basis of control by a servo control circuit 1013. The entire optical head 1004 is moved in the radial direction of the information storage medium 9 by a carriage 1010. The semiconductor laser LD 1006 is driven and controlled by a laser drive control circuit 1012. The light beam 1001 emitted from the semiconductor laser LD 1006 passes through the optical system 1007, is condensed by the objective lens 1002, and then focused on the information storage medium 9. Reflected light from the information storage medium 9 passes through the objective lens 1002 and optical system 1007 and then becomes incident on the division photodetector PD 1005. The multiple division photodetector PD 1005 functions as a 2-division push-pull detector. A wobbled signal is played back using a signal (difference signal) detected by the 2-division push-pull detector. To read an RF signal such as user information, incident light components of the division detector are added and detected as a sum signal. The detected wobbled signal and user information are processed by a signal processing circuit 1014 and data processing circuit 1015.

A wobbled signal demodulation circuit will be described next. FIG. 7 shows the arrangement of the wobbled signal demodulation circuit. This circuit corresponds to part of the signal processing circuit 1014 shown in FIG. 6. This demodulation circuit mainly demodulates data such as address data modulated as a wobbled signal and also generates a rotation control signal of the spindle motor, a reference clock for information recording, a sync pattern using a delay detection output, and the like. On the basis of the demodulated address data, target user information is recorded at the target position by the optical head 1004. Alternatively, on the basis of the demodulated address data, target user information is played back from the target position by the optical head 1004.

The input wobbled signal is converted into target information mainly through four paths.

In the first path, the wobbled signal is input to a broad bandpass filter 531. In this path, the wobbled signal passes through the broad bandpass filter 531 and then is converted into a binary signal by a binarization circuit 532. Subsequently, the number of appearing pulses is counted by a pulse count circuit 533. Then, the numbers of appearing pulses per unit time are averaged by a digital filter circuit 534. The number of appearing pulses per unit time represents the wobble frequency. Hence, the result can be used as a wobble clock frequency estimated value. The ideal value of the wobble clock frequency estimated value is known in advance on the basis of the appearance probability of the four frequencies of 4-frequency shift keying used to modulate the wobbled signal. Hence, the rotational speed of the spindle motor 1008 can be controlled using the wobble clock frequency estimated value. More specifically, the ideal value of the wobble clock frequency estimated value is compared with the actual output of the first path. When the rotational speed of the spindle motor 1008 is controlled to reduce the difference, the spindle motor 1008 obtains an almost ideal rotational speed. This operation is performed when the demodulation circuit as the second path (to be described next) is not in synchronism, e.g., when the information recording/playback apparatus is activated.

In the second path, the wobbled signal is input to bandpass filters corresponding to the four frequencies used to modulate the wobbled signal. This path is the demodulation circuit for address data and the like. The output signal from a bandpass filter is subsequently input to a decoder circuit 546. Each of the bandpass filters 541 to 544 outputs a signal only when a corresponding frequency appears in the wobbled signal. When a frequency that does not correspond is input, the bandpass filter outputs no signal. For this reason, when the presence/absence of the output signals for the bandpass filters 541 to 544 is detected, one of [f2] to [f6], which is currently being played back, can be detected. The decoder circuit 546 executes this detection processing. At this time, the signal is sampled and held using one sync frame timing signal extracted by the delay detection circuit 550 (to be described later). The four signals corresponding to [f2] to [f6] detected by the decoder circuit are input to a quaternary-to-binary inverse conversion circuit 547 and converted into binary signals. The binary signal is used as playback information such as address data.

In the third path, the wobbled signal is input to the delay detection circuit 550. The input wobbled signal is further divided into two paths. One is a path through which the wobbled signal is directly input to a multiplying circuit 552, and the other is a path through which the wobbled signal is input to the multiplying circuit 552 through a delay circuit 551. The delay circuit delays the input wobbled signal by one time slot. The signals from the two paths are multiplied by the multiplying circuit 552. The multiplied signal is integrated over one time slot by a Ts period integration circuit and output from the delay detection circuit. In this embodiment, the four frequencies used to modulate the wobbled signal have an orthogonal relationship. Hence, the output from the delay detection circuit is zero at the frequency switching point by multiplication and integration processing as indicated by equation (10). When a frequency continues, a signal of predetermined level is output. This output is input to the decoder circuit 546, quaternary-to-binary inverse conversion circuit, and wobbled header position detection circuit and used as sample-and-hold timing data and position detection information of the wobbled header area 501. The signal is also used as wobbled address mark playback information and pre-sync information in recording user information.

In the fourth path, the wobbled signal is input to a binarization circuit 571. The binarized signal is input to an address data read PLL circuit 572 and reference clock extraction PLL circuit 573 for recording. The outputs from these circuits are used as a clock for playing back segment address data and a reference clock for recording user information, respectively.

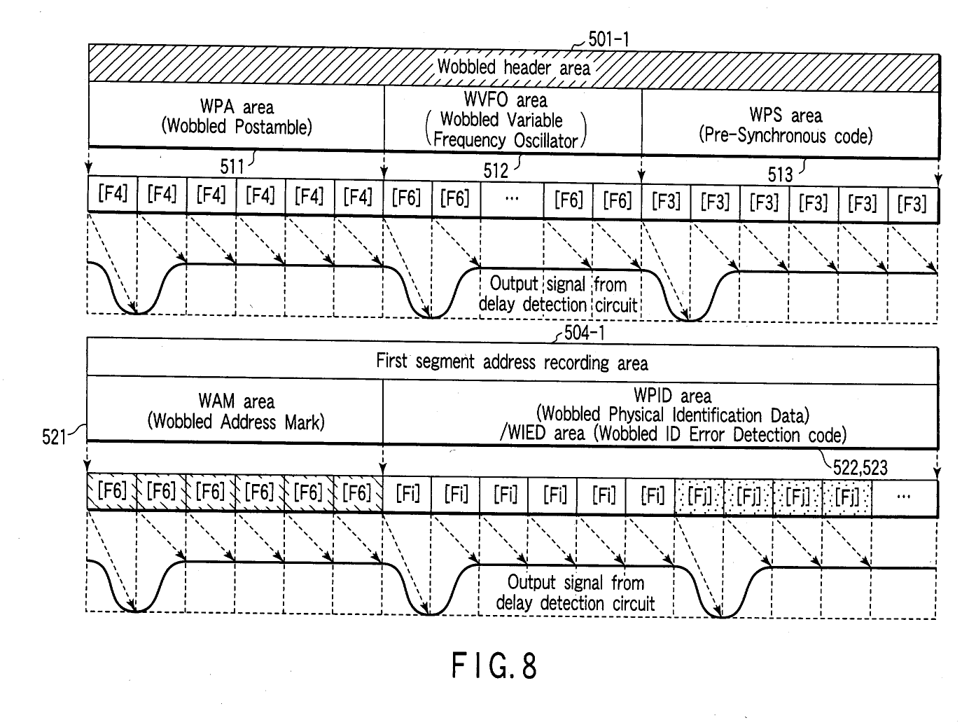

The output of the delay detection circuit in each area of a segment and a method of using the output will be described next. FIG. 8 shows the output of the delay detection circuit in each area of a segment. As described above, when the frequency continues, the delay detection circuit outputs a signal of predetermined level. When the frequency is switched, the delay detection circuit outputs no signal. An output signal of predetermined level is defined as “1”, and a non-output portion is defined as “0”. As described above, a wobbled signal is recorded such that the same symbol continues in each of the WPA area 511, WVFO area 512, WPS area 513, and WAM area 521, and the frequency is switched between the areas. Hence, the output from the delay detection circuit 550 is always “0” at the start of each area except the WPA area 511 and always “1” at the remaining portions.

Wobbled physical address information and its error correction information are modulated to four symbols in accordance with a predetermined wobble modulation rule and recorded in the WPID area 522 and WIED area 523, respectively. Hence, as the delay detection output, “1” continues at least for one sync frame. The longest continuous period of “1” is determined depending on the run-length constraint of the modulation rule. That is, “1” does not continue beyond the run-length constraint in these two areas.

A method of determining each area using the delay detection output will be described. First, a method of detecting the WVFO area 512 will be described. The WVFO area 512 is longer than one physical sector. That is, the WVFO area 512 is the only area where “1” continues beyond the run-length constraint. Hence, when that “1” continues as the delay detection output signal is detected, and that the length exceeds the run-length constraint is determined, it can be known that the area is the WVFO area 512.

Next, when a portion immediately after the WVFO area 512, at which the delay detection output changes from “1” to “0”, is detected, it can be known that the WPS area 513 starts.

Next, when a portion immediately after the WPS area 513, at which the delay detection output changes from “1” to “0”, is detected, the WAM area 521 starts. The WAM area 521 should have one sync frame length. Hence, it can be determined that the area after one sync frame from the start of the WAM area 521 is the WPID area 522 of the first segment address recording area.

The symbols and the symbol continuous sections in the WPA area 511, WVFO area 512, WPS area 513, and WAM area 521 are defined. Hence, even without using the delay detection output, each area can be determined by detecting the frequency of the symbol in each area by the demodulation circuit. For example, a portion where F6 continues beyond the run-length constraint of the wobble modulation rule is detected from the output of the bandpass filter circuit 544 corresponding to F6 shown in FIG. 7 to determine the WVFO area 512, i.e., the wobbled header area 501. After that, when the output from the bandpass filter circuit 542 corresponding to F3 is detected, it can be determined that the area is the WPS area 513. Subsequently, when the output from the bandpass filter circuit 544 corresponding to F6 is detected, it can be determined that the area is the WAM area 521 of the segment first address recording area. The appearance interval of the WAM areas 521 of the second and third segment address recording areas 504-2 and 504-3 can be predicted. Near the appearance timing, reception of the output from the bandpass filter circuit 544 corresponding to F6 is started. If a signal is detected, it can be determined that the area is the WAM area 521 of the second segment address recording area 504-2 or third segment address recording area 504-3. If F6 is detected at the end of the WIED area 523, the determination accuracy of the WAM area 521 decreases. In this case, the decrease in accuracy can be suppressed by imposing such a constraint that binary error correction information of the wobbled address should be modulated to quaternary information whose last symbol has a value except F6 serving as a wobbled address mark.

In addition to the above determination, the WVFO area 512 is determined using the above-described delay detection output. Also, the appearance positions of the WPS area 513 and WAM area 521 are determined using the delay detection circuit output half timing. Then, the areas can be more accurately determined. Furthermore, when the WAM area 521 is accurately determined, the start of the WPID area can be reliably detected. Hence, the wobbled address data read probability increases. When the WPS area 513 is accurately detected, the user data recording start position can be accurately defined.

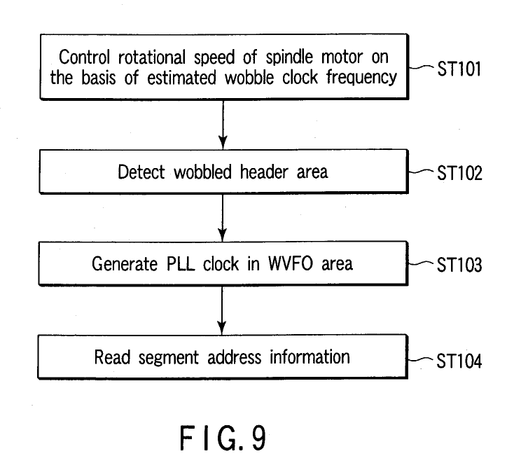

Initial operation for playing back information from the information storage medium 9 will be described with reference to the flowchart shown in FIG. 9.

When the information storage medium 9 is inserted into the information recording/playback apparatus, the spindle motor 1008 rotates. The optical head 1004 is moved to a predetermined position by the carriage 1010. Then, focus and tracking control is executed, and information recorded on the track of the information storage medium 9 is played back.

Immediately after the start of playback of the information storage medium 9, the spindle motor 1008 does not have the rotational speed that should be. Hence, the rotational speed is controlled first. As described above with reference to FIG. 7, the rotational speed is controlled by making the wobble clock frequency estimated value generated from the wobbled signal close to an ideal state. Accordingly, the rotational speed of the spindle motor 1008 is roughly controlled (Step 101).

Next, a portion where [F6] is continuously detected over the normal run-length is searched for from the output of the bandpass filter circuit 544 corresponding to [F6]. Thus, the wobbled header area 501 and, more particularly, the WVFO area 512 are determined. If the rotational speed largely deviates from the ideal state, the frequency of [F6] contained in the wobbled signal largely shifts and falls outside the detection range of the bandpass filter corresponding to [F6]. Even when the rotational speed largely deviates from the ideal value, the WVFO area can reliably be detected using the above-described output from the delay detection circuit (Step 102). When the WVFO area is determined, the address data read PLL is pulled in, and the rotational speed of the spindle motor is stably controlled (Step 103). Next, the WAM area is detected, and address data is read from the playback signals in the subsequent WPID area and WIED area (Step 104).

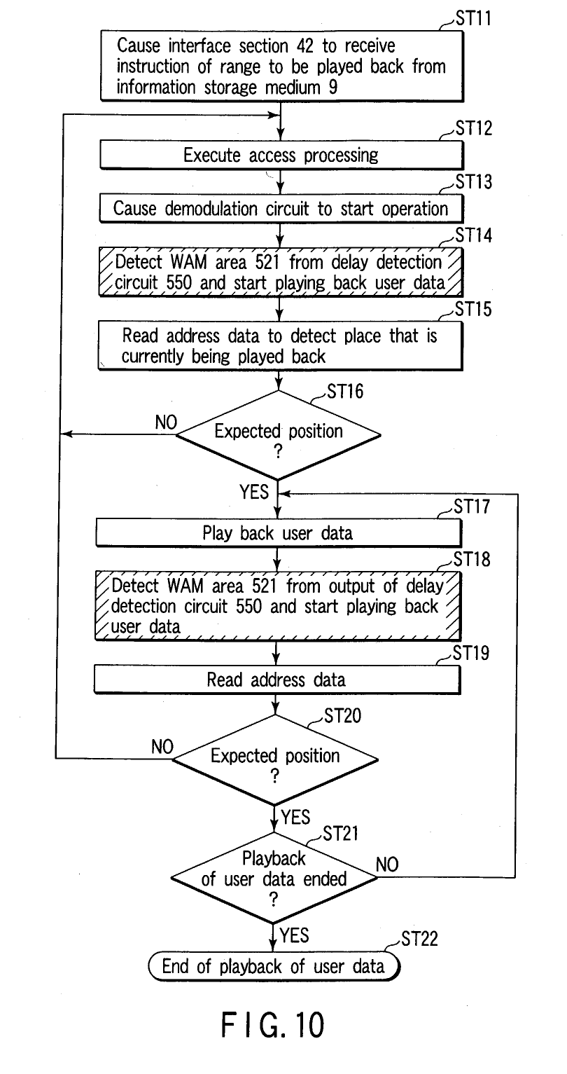

The flow for playing back information from the information storage medium 9 will be described with reference to the flowchart shown in FIG. 10. First, an interface 1017 receives, from an external device, an instruction for a range to be played back from the information storage medium 9 (ST11). Next, the optical head 1004 is moved by the carriage to a rough radial position in the range where the requested information is present (ST12). The rotational speed of the spindle motor is controlled. Then, the operation of the demodulation circuit is started (ST13). The WAM area 521 is detected from the output from the demodulation circuit and the output from the delay detection circuit 550, and the read of the wobbled address data is started (ST14). The address that is being read is detected from the read data (ST15). Under majority rule for three pieces of read segment address information, i.e., when at least two identical addresses are present, the address is detected as the segment address. When the detected address is not the expected address, track jump and movement of the optical head 1004 are executed again (ST12). This operation is repeated until the expected position is detected. If the detected address is the expected address, user data is played back from that point (ST17). As described above, when the WAM area is detected using the output from the demodulation circuit and the output from the delay detection circuit 550, the physical sector data 5 in which the user data is recorded starts immediately after the WAM area. The physical sector data 5 is played back (ST18). Even during user data playback, the wobbled address of the segment is already read (ST19). If the read wobbled address is not the expected address, track jump and optical head movement are executed again (ST12). The operation is repeated until the expected position is detected (ST20). The above processing is continued until user data playback is ended (ST21). When the user data is completely played back, the playback processing is ended (ST22).

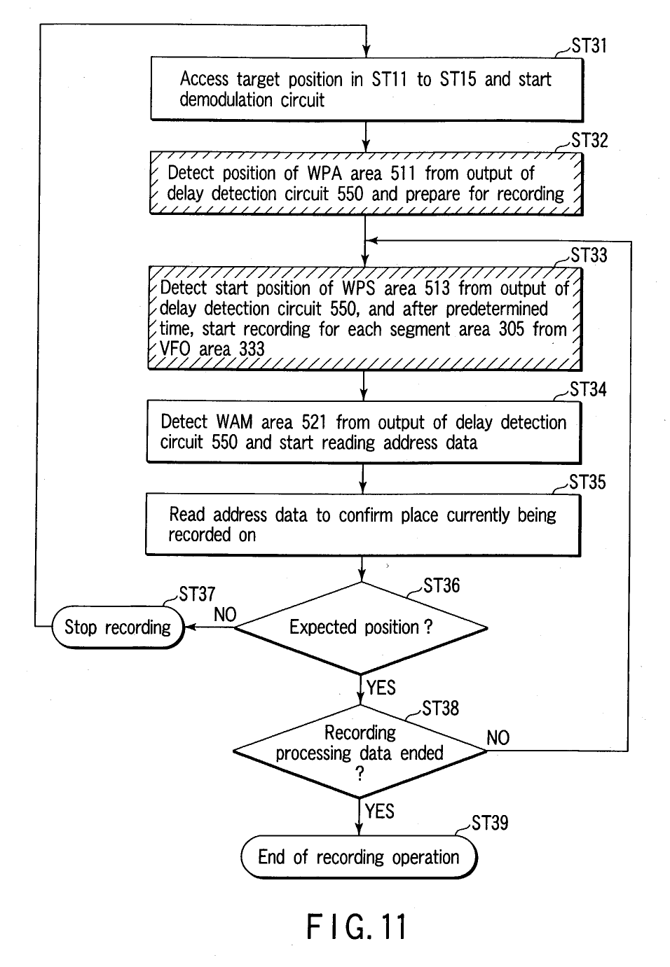

The flow of recording control in this embodiment will be described with reference to the flowchart shown in FIG. 11. When the interface received, from the external device, user information to be recorded on the information medium 9 and the range of the user information, the same processing as in (ST12) to (ST15) described above is executed, and the light beam is moved to the recording start position. When the light beam approaches the recording start position, the demodulation circuit is started (ST31). The locations of the WPA area 511 and WVFO area 512 are detected from the outputs from the demodulation circuit and delay detection circuit 550, and preparation for recording is started (ST32). When the start position of the WPS area 513 is detected from the outputs from the demodulation circuit and delay detection circuit 550, processing waits for a predetermined time. Then, recording of the user information is started from the VFO area 333 for each segment area 305 (ST33). Simultaneously, the WAM area 521 is detected from the outputs from the demodulation circuit and delay detection circuit 550, and the read of address information of the segment is started (ST34). Even during recording the user information, the segment address is continuously read to confirm the current recording position (ST35). If the read segment address is not the expected address, recording is stopped, and the flow returns to the start (ST37). The above processing is continued until the user information is completely recorded. When the information to be recorded is ended (ST38), the recording operation is ended (ST39).

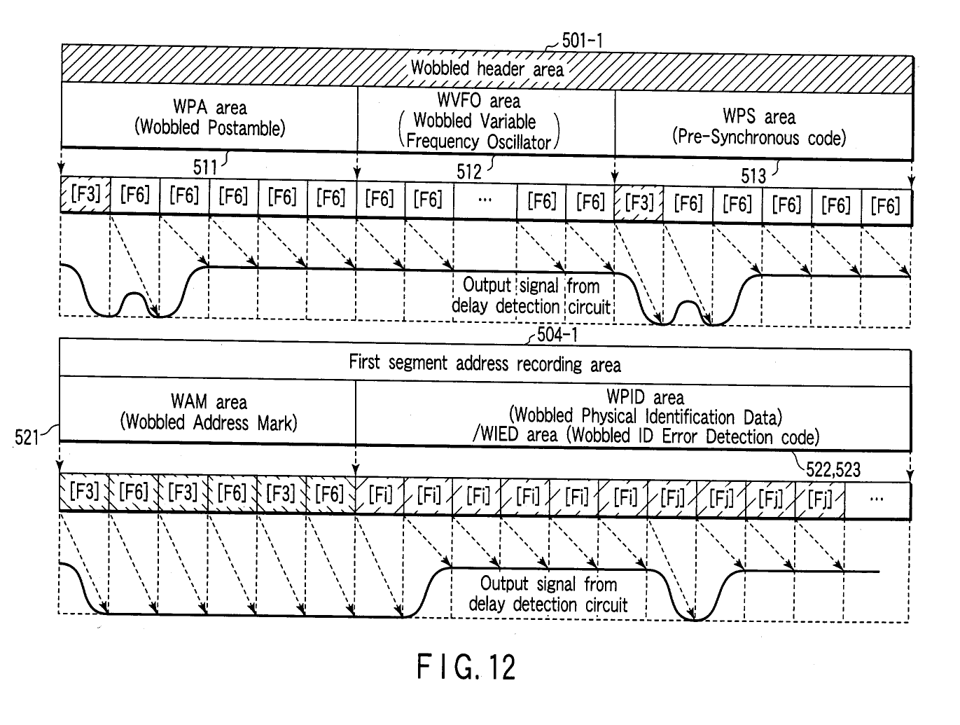

The second embodiment will be described next. A wobbled signal that is more effective in using the delay detection output to determine each area of a segment will be described. FIG. 12 is a view showing a wobbled signal according to the second embodiment of the present invention. More specifically, wobbled signals recorded in a wobbled header area 501-1 and first segment address recording area 504-1 are shown. Signals identical to that in the first segment address recording area 504-1 are recorded in second and third segment address recording areas 504-2 and 504-3.

In a WPA area 511, as a wobbled postamble, F3 is recorded only in one slot, and F6 is recorded in the remaining slots. In a WVFO area 512, F6 is repeatedly recorded as a wobbled VFO. In a WPS area 513, as a wobbled pre-synchronous code, F3 is recorded only in the first slot, and F6 is recorded in the remaining slots. In a WAM area 521, as a wobbled address mark, F3 is recorded in the first slot, F6 is recorded in the second slot, and so on. That is, F3 and F6 are alternately recorded in the slots. In a WPID area 522, a value obtained by modulating the segment address information is recorded by switching the symbol for each sync frame. In a WIED area 523, a value obtained by modulating the error correction information of the segment address information is recorded by switching the symbol for each sync frame.

In the above manner, in each area of the wobbled header area 501, the frequency is switched not for one wobbled word defined in advance but at one slot interval. In this way, the delay detection output is recorded with a pattern different from those in the remaining areas. Hence, when the delay detection output is detected, each area can easily and reliably be determined.

The output from the delay detection circuit in each area of a segment and a method of using the output will be described next. FIG. 12 shows the output of the delay detection circuit in each area of a segment. As described above, when the frequency continues, the delay detection circuit outputs a signal of predetermined level. When the frequency is switched, the delay detection circuit outputs no signal. An output signal of predetermined level is defined as “1”, and a non-output portion is defined as “0”.

As described above, wobbled physical address information and its error correction information are modulated to four symbols in accordance with a predetermined wobble modulation rule and recorded in the WPID area 522 and WIED area 523, respectively. In the WPID area 522 and WIED area 523, the same symbol should continue in one sync frame. Hence, in the WPID area 522 and WIED area 523, the signal changes to “0” for one slot only at the start of a sync frame at which the delay detection output indicates the symbol switching point. At the remaining portions, the signal is “1”. In addition, as the delay detection output, “1” continues at least for one sync frame. The longest continuous period of “1” is determined depending on the run-length constraint of the modulation rule. That is, “1” does not continue beyond the run-length constraint in these two areas.

A method of determining each area using the delay detection output will be described. First, a method of detecting the WVFO area 512 will be described. The WVFO area 512 is longer than one physical sector. That is, the WVFO area 512 is the only area where “1” continues beyond the run-length constraint. Hence, when that “1” continues as the delay detection output signal is detected, and that the length exceeds the run-length constraint is determined, it can be known that the area is the WVFO area 512.

Next, after determination of the WVFO area 512, immediately after the output from the delay detection circuit is inverted, the area can be determined as a WPS area 513. In the WPS area 513, the output from the delay detection circuit changes to “0” for two slots at the boundary with respect to the WVFO area 512. The signal is “1” at the remaining portions. The pattern in which the signal changes to “0” for two slots and remains “1” for four slots is generated only in the WPS area 513 and WPA area 511. Hence, when the pattern of the output from the delay detection circuit is detected, the WPS area 513 can be more reliably determined.

Subsequently, after determination of the WPS area 513, immediately after the output from the delay detection circuit is inverted, the area can be determined as a WAM area 521. In the WAM area 521, the output from the delay detection circuit is always “0”. The pattern in which the signal remains “0” for six slots is generated only in the WAM area 521. Hence, when the pattern of the output from the delay detection circuit is detected, the WAM area 521 can reliably be determined. When such a pattern is detected, the WPS area 513 and WAM area 521 can directly be determined without continuous detection from the WVFO area 512.

The third embodiment will be described next. A case wherein orthogonal 2-frequency shift keying is used as a wobbled signal modulation method will be described. Symbols employed in the third embodiment are F2 and F3 used in the first embodiment. In this case, when m=0.5 and N=2 in the description of equations (1) to (9) of multi-frequency shift keying, i=1 and i=2 are used as symbols. This is generally called MSK.

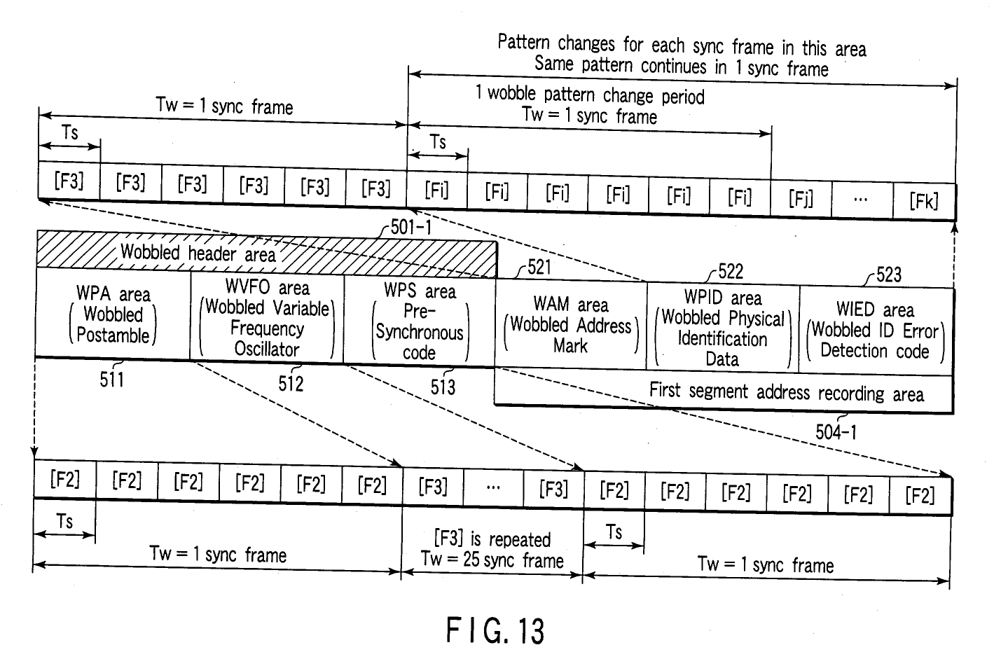

FIG. 13 shows wobbled signals recorded in a wobbled header area 501-1 and first segment address recording area 504-1. Signals identical to that in the first segment address recording area 504-1 are recorded in second and third segment address recording areas 504-2 and 504-3.

F2 is entirely recorded in a WPA area 511 as a wobbled postamble. In a WVFO area 512, F6 is repeatedly recorded as a wobbled VFO. In a WPS area 513, F3 is recorded again as a wobbled pre-synchronous code. In a WAM area 521, F3 is recorded as a wobbled address mark. In a WPID area 522, a value obtained by modulating the segment address information is recorded by switching the symbol for each sync frame.

The output from the delay detection circuit in each area of a segment and a method of using the output will be described next. As described above, when the frequency continues, the delay detection circuit outputs a signal of predetermined level. When the frequency is switched, the delay detection circuit outputs no signal. An output signal of predetermined level is defined as “1”, and a non-output portion is defined as “0”. As described above, the wobbled signal is recorded such that the same symbol continues in each of the WPA area 511, WVFO area 512, WPS area 513, and WAM area 521, and the frequency is switched between the areas. Hence, the delay detection output is always “0” at the start of each area except the WPA area 511 and always “1” at the remaining portions.

Wobbled physical address information and its error correction information are modulated to two symbols in accordance with a predetermined wobble modulation rule and recorded in the WPID area 522 and WIED area 523, respectively. As the shortest delay detection output, “1” continues at least for one sync frame. The longest continuous period of “1” is determined depending on the run-length constraint of the modulation rule. That is, “1” does not continue beyond the run-length constraint in these two areas.

A method of determining each area using the delay detection output will be described. First, a method of detecting the WVFO area 512 will be described. The WVFO area 512 is longer than one physical sector. That is, the WVFO area 512 is the only area where “1” continues beyond the run-length constraint. Hence, when it is detected that “1” continues as the delay detection output signal, and it is determined that the length exceeds the run-length constraint, it can be known that the area is the WVFO area 512.

Next, when a portion immediately after the WVFO area 512, at which the output from the delay detection circuit changes from “1” to “0”, is detected, it can be known that the WAM area 513 starts from that portion.

When a portion immediately after the WPS area 513, at which the delay detection output changes from “1” to “0”, is detected, the WAM area 521 starts from that portion. The WAM area 521 should have one sync frame length. Hence, it can be determined that the area after one sync frame from the determined start of the WAM area 521 is the WPID area 522 of the first segment address recording area.

The symbols and the symbol continuous sections in the WPA, WVFO, WPS, and WAM areas are defined. Hence, even without using the delay detection output, each area can be determined by detecting the frequency of the symbol in each area by the demodulation circuit. For example, a portion where F3 continues beyond the run-length constraint of the wobble modulation rule is detected from the output of a bandpass filter circuit 544 corresponding to F3 shown in FIG. 7 to determine the WVFO area 512, i.e., the wobbled header area 501. After that, when the output from a bandpass filter circuit 542 corresponding to F2 is detected, it can be determined that the area is the WPS area 513. Subsequently, when the output from the bandpass filter circuit 544 corresponding to F3 is detected, it can be determined that the area is the WAM area 521 of the segment first address recording area 504-1. The appearance interval of the WAM areas 521 of the second and third segment address recording areas 504-2 and 504-3 can be predicted. Near the appearance timing, reception of the output from the bandpass filter circuit 544 corresponding to F6 is started. If a signal is detected, it can be determined that the area is the WAM area 521 of the second segment address recording area 504-2 or third segment address recording area 504-3. If F2 is detected at the end of the WIED area, the determination accuracy of the WAM area 521 decreases. In this case, the decrease in accuracy can be suppressed by imposing such a constraint that error correction information of the wobbled address should be modulated to binary information whose last symbol has a value except F2 serving as a wobbled address mark.

In addition to the above determination, the WVFO area 512 is determined using the above-described delay detection output. Also, the appearance positions of the WPS area 513 and WAM area 521 are determined using the delay detection circuit output half timing. Then, the areas can be more accurately determined. Furthermore, when the WAM area 521 is accurately determined, the start of the WPID area 522 can be reliably detected. Hence, the wobbled address data read probability increases. When the WPS area 513 is accurately detected, the user data recording start position can be accurately defined.

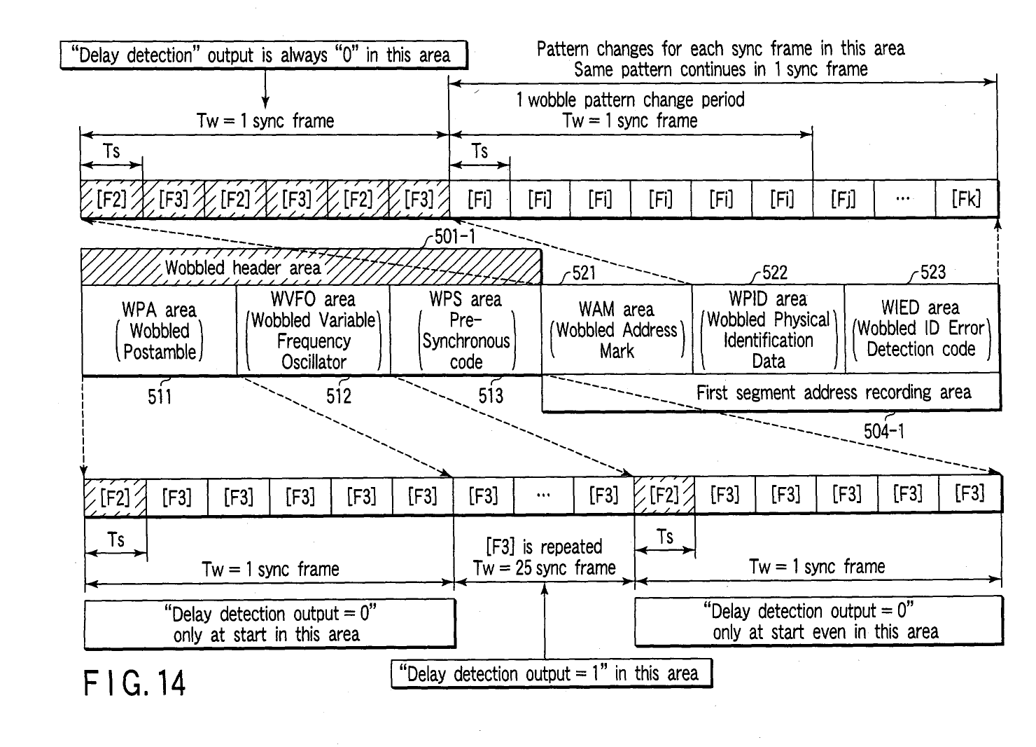

The fourth embodiment will be described next. A wobbled signal that is more effective in using the delay detection output to determine each area of a segment will be described. FIG. 14 is a view showing a wobbled signal according to the fourth embodiment of the present invention. More specifically, wobbled signals recorded in a wobbled header area 501-1 and first segment address recording area 504-1 are shown. Signals identical to that in the first segment address recording area 504-1 are recorded in second and third segment address recording areas 504-2 and 504-3.

In a WPA area 511, as a wobbled postamble, F2 is recorded only in one slot, and F3 is recorded in the remaining slots. In a WVFO area 512, F3 is repeatedly recorded as a wobbled VFO. In a WPS area 513, as a wobbled pre-synchronous code, F2 is recorded only in the first slot, and F3 is recorded in the remaining slots. In a WAM area 521, as a wobbled address mark, F2 is recorded in the first slot, F3 is recorded in the second slot, and so on. That is, F2 and F3 are alternately recorded in the slots. In a WPID area 522, a value obtained by modulating the segment address information is recorded by switching the symbol for each sync frame. In a WIED area 523, a value obtained by modulating the error correction information of the segment address information is recorded by switching the symbol for each sync frame.

In the above manner, in each area wobbled header area 501, the frequency is switched not for one wobbled word defined in advance but at one slot interval. In this way, the delay detection output is recorded with a pattern different from the patterns in the remaining areas. Hence, when the delay detection output is detected, each area can easily and reliably be determined.

The output from the delay detection circuit in each area of a segment and a method of using the output will be described next. As described above, when the frequency continues, the delay detection circuit outputs a signal of predetermined level. When the frequency is switched, the delay detection circuit outputs no signal. An output signal of predetermined level is defined as “1”, and a non-output portion is defined as “0”.

Wobbled physical address information and its error correction information are modulated to two symbols in accordance with a predetermined wobble modulation rule and recorded in the WPID area 522 and WIED area 523, respectively. In the WPID area 522 and WIED area 523, the same symbol should continue in one sync frame. Hence, in the WPID area 522 and WIED area 523, the signal changes to “0” for one slot only at the start of a sync frame at which the delay detection output indicates the symbol switching point. At the remaining portions, the signal is “1”. In addition, as the delay detection output, “1” continues for at least one sync frame. The longest continuous period of “1” is determined depending on the run-length constraint of the modulation rule. That is, “1” does not continue beyond the run-length constraint in these two areas.

A method of determining each area using the delay detection output will be described. First, a method of detecting the WVFO area 512 will be described. The WVFO area 512 is longer than one physical sector. That is, the WVFO area 512 is the only area where “1” continues beyond the run-length constraint. Hence, when it is detected that “1” continues as the delay detection output signal, and it is determined that the length exceeds the run-length constraint, it can be known that the area is the WVFO area 512.

Next, after determination of the WVFO area 512, immediately after the output from the delay detection circuit is inverted, the area can be determined as a WPS area 513. In the WPS area 513, the output from the delay detection circuit changes to “0” for two slots at the boundary with respect to the WVFO area 512. The signal is “1” at the remaining portions. The pattern in which the signal changes to “0” for two slots and remains “1” for four slots is generated only in the WPS area 513 and WPA area 511. Hence, when the pattern of the output from the delay detection circuit is detected roughly at the appearance timing, the WPS area 513 can be more reliably determined.

Subsequently, after determination of the WPS area 513, immediately after the output from the delay detection circuit is inverted, the area can be determined as a WAM area 521. In the WAM area 521, the output from the delay detection circuit is always “0”. The pattern in which the signal remains “0” for six slots is generated only in the WAM area 521. Hence, when the pattern of the output from the delay detection circuit is detected, the WAM area 521 can be reliably determined. When such a pattern is detected, the WPS area 513 and WAM area 521 can be directly determined without continuous detection from the WVFO area 512.

In this embodiment, all pieces of control information are recorded using multi-frequency shift keying using orthogonal frequencies. The present invention can also provide its effect when only sync information such as the WPA area, WPS area, WVFO area, or WAM area is recorded using multi-frequency shift keying using orthogonal frequencies even if address information such as the WPID area or WIED area is recorded using a different modulation scheme.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information storage medium comprising:
a wobbled track containing a wobble modulated in correspondence with playback control information,
wherein the playback control information contains header data,
part of the header data contains at least one item of sync information, and
the frequency of the wobble changes at the boundary of the sync information.

2. A medium according to claim 1, wherein
the playback control information contains address data and the header data,
part of the address data and the header data contains at least one item of sync information, and
the frequency of the wobble changes at the boundary of the sync information.

3. A medium according to claim 1, wherein
as a modulation scheme for a portion indicating the sync information in the wobbled track, at least multi-frequency shift keying is used, and
frequencies contained in the multi-frequency shift keying have an orthogonal relationship.

4. A medium according to claim 1, wherein the sync information is arranged at least at one of the start position of the address data, the start position of the header data, and the end position of the header data.

5. A medium according to claim 1, wherein
the sync information is formed for each word,
the one word is formed from a plurality of time slots, and
one time slot contained in specific sync information has a symbol different from remaining time slots contained in the specific sync information.

6. A medium according to claim 2, wherein
the wobbled track has a plurality of segment areas,
each of the segment areas contains the header data and the address data, and
the segment area can store a plurality of sector data in synchronism with the sync information.

7. An information recording apparatus which records information on an information storage medium having a wobbled track containing a wobble modulated in correspondence with playback control information, in which the playback control information contains header data and address data, part of each of the header data and the address data contains at least one item of sync information, and the frequency of the wobble changes at the boundary of the sync information, comprising:
a read section configured to read the playback control information from the wobble contained in the wobbled track;
a sync signal detection section configured to detect a sync signal from the sync information contained in the playback control information read by the read section; and
a recording section configured to play back the header data and the address data in synchronism with the sync signal detected by the sync signal detection section and record target information at a target position on the basis of the address data.

8. An apparatus according to claim 7, wherein the sync signal detection section includes a delay detection circuit.

9. An information playback apparatus which plays back information from an information storage medium having a wobbled track containing a wobble modulated in correspondence with playback control information, in which the playback control information contains header data and address data, part of each of the header data and the address data contains at least one item of sync information, and the frequency of the wobble changes at the boundary of the sync information, comprising:
a read section configured to read the playback control information from the wobble contained in the wobbled track;
a sync signal detection section configured to detect a sync signal from the sync information contained in the playback control information read by the read section; and
a playback section configured to play back the header data and the address data in synchronism with the sync signal detected by the sync signal detection section and playing back target information from a target position on the basis of the address data.

10. An apparatus according to claim 9, wherein the sync signal detection section includes a delay detection circuit.
